(19) United States
(12) Patent Application Publication
(10) Pub. No.: US 2025/0130373 A1
(43) Pub. Date: Apr. 24, 2025

(54) FIBER OPTIC CONNECTOR CONFIGURED TO PREVENT MOVEMENT OF A REINFORCING PORTION OF A FIBER OPTIC CABLE DURING FIELD TERMINATION OF THE FIBER OPTIC CABLE

(71) Applicant: Belden Canada ULC, Saint-Laurent (CA)

(72) Inventor: MASSIMO P. CARBONI, Montreal (CA)

(73) Assignee: Belden Canada ULC, Saint-Laurent (CA)

(21) Appl. No.: 18/920,566

(22) Filed: Oct. 18, 2024

Related U.S. Application Data
(60) Provisional application No. 63/544,665, filed on Oct. 18, 2023.

(51) Int. Cl. G02B 6/38; G02B 6/44

(52) U.S. Cl. CPC G02B 6/3816; G02B 6/4478

(57) ABSTRACT

A fiber optic connector may include a body portion having a first end portion structurally configured to connect a fiber optic cable to an interface of a network component, a coupling portion at a second end portion of the body portion opposite to the first end portion, and a bonding portion disposed on at least a portion of the coupling portion. The coupling portion may include an exterior surface portion structurally configured to comprise an engagement portion and a receiving portion defined by the engagement portion, and at least a portion of the receiving portion may be structurally configured to receive the bonding portion. The bonding portion is structurally configured to retain a reinforcing portion of a fiber optic cable during field installation of the connector on the fiber optic cable with the connector so as to prevent movement of the reinforcing portion relative to the body portion.

### CROSS-REFERENCE TO RELATED APPLICATION

This application claims the benefit of U.S. Provisional Application No. 63/544,665, filed Oct. 18, 2023, which is currently pending, the disclosure of which is hereby incorporated by reference herein in its entirety.

### TECHNICAL FIELD

The present disclosure is directed to cable termination and, more particularly, to a fiber optic connector configured to retain a reinforcing portion of a fiber optic cable during field installation of the connector on the fiber optic cable with the connector so as to prevent movement of the reinforcing portion relative to the body portion.

### BACKGROUND

As signal cables have become more sophisticated to provide greater capabilities, the operational tolerances have become more important for peak performance. The physical tolerances associated with fiber optic signal cable, for example, can restrict the installation configurations and possible operational environments. To address restricted cable tolerances associated with cables bending and/or stretching, reinforcing materials can be incorporated into portions of a cable.

While reinforcing materials, such as fabric, rubber, or polymers, can strengthen portions of a cable and increase the reliability of signal transmission despite dynamic physical forces, the installation of such reinforced cables can be time consuming and imprecise, which can degrade nominal and/or peak signal transmission performance for the cable. For instance, material used to reinforce a cable can twist, kink, break, or bind to impose inadvertent forces on a cable, instead of protecting the force. Such inadvertent forces can pose operational difficulties for a cable that degrade, or eliminate, signal transmission characteristics. For these reasons, it is a continued goal for cables configured to carry signals to have reinforcement that takes less time to install and is less susceptible to installation errors.

Further, conventional installation of field terminated fiber optic connectors with reinforced jacketed cable of any diameter is done by either: having an excessive length of the reinforcing material (e.g., Kevlar) that the installer will physically hold during installation to prevent any twisting; or having additional plastic molded, die cast, or machined components or clips added to the design of the fiber optic connector rear body that will first secure the reinforcing material in place, and then allow for a fastening installation of the connector boot to finish the connector termination.

Accordingly, it may be desirable to provide a fiber optic connector including bonding portion structurally configured to retain a reinforcing portion of a fiber optic cable during field installation of the connector on the fiber optic cable with the connector so as to prevent movement of the reinforcing portion relative to the body portion. In some aspects, it may be desirable to provide a fiber optic connector including a bonding portion is configured to prevent twisting, tearing, and/or slipping of the reinforcing portion relative to the body portion when coupling the engagement portion with a cap portion during the field installation of the connector on the fiber optic cable.

### SUMMARY

In accordance with various aspects of the disclosure, a fiber optic connector may include a body portion having a first end portion structurally configured to connect a fiber optic cable to an interface of a network component, a first coupling portion at a second end portion of the body portion opposite to the first end portion, a second coupling portion continuously extending from the first coupling portion in a direction toward the first end portion and having a larger outside diameter than the first coupling portion, and a bonding portion disposed on at least a portion of the first coupling portion and at least a portion of the second coupling portion. The first coupling portion may include an exterior surface portion structurally configured to comprise a first engagement portion and a first receiving portion defined by the first engagement portion, and the second coupling portion may include an exterior surface portion structurally configured to comprise a second engagement portion and a second receiving portion defined by the second engagement portion. At least a portion of the first receiving portion and at least a portion of the second receiving portion may be structurally configured to receive the bonding portion, and the first engagement portion and the second engagement portion may be structurally configured to couple with a cap portion. The bonding portion may be structurally configured to retain a reinforcing portion of a fiber optic cable during field installation of the connector on the fiber optic cable with the connector so as to prevent movement of the reinforcing portion relative to the body portion

In some embodiments of any of the aforementioned connectors, the bonding portion may be configured to prevent twisting, tearing, and/or slipping of the reinforcing portion relative to the body portion when coupling the engagement portion with a cap portion during the field installation of the connector on the fiber optic cable.

In some embodiments of any of the aforementioned connectors, the bonding portion may be configured to prevent twisting, tearing, and/or slipping of the reinforcing portion relative to the body portion.

In some embodiments of any of the aforementioned connectors, the bonding portion may be configured to provide enhanced pull strength between the connector and the fiber optic cable.

In some embodiments of any of the aforementioned connectors, the bonding portion may comprise a thermoplastic elastomer material.

In some embodiments of any of the aforementioned connectors, the bonding portion may comprise a methacrylate-based epoxy.

According to various aspect of the disclosure, a fiber optic connector may include a body portion having a first end portion structurally configured to connect a fiber optic cable to an interface of a network component, a first coupling portion at a second end portion of the body portion opposite to the first end portion, a second coupling portion extending from the first coupling portion in a direction toward the first end portion and having a larger outside diameter than the first coupling portion, and a bonding portion disposed on at least a portion of at least one of the first coupling portion and the second coupling portion. The first coupling portion may include an exterior surface portion comprising a first receiving portion, the second coupling portion may include an exterior surface portion comprising a second receiving portion, and at least a portion of at least one of the first receiving portion and the second receiving portion may be structurally configured to receive the bonding portion. The bonding portion may be structurally configured to retain a reinforcing portion of a fiber optic cable during field installation of the connector on the fiber optic cable with the connector so as to prevent movement of the reinforcing portion relative to the body portion.

In some embodiments of any of the aforementioned connectors, the exterior surface portion of the first coupling portion may include a first engagement portion structurally configured to define the first receiving portion, the exterior surface portion of the second coupling portion may include a second engagement portion structurally configured to define the second receiving portion, and at least one of the first engagement portion and the second engagement portion may be structurally configured to couple with a cap portion during field installation of the connector on the fiber optic cable.

In some embodiments of any of the aforementioned connectors, the bonding portion may be configured to prevent twisting, tearing, and/or slipping of the reinforcing portion relative to the body portion when coupling the engagement portion with a cap portion during the field installation of the connector on the fiber optic cable.

In some embodiments of any of the aforementioned connectors, the bonding portion may be configured to prevent twisting, tearing, and/or slipping of the reinforcing portion relative to the body portion.

In some embodiments of any of the aforementioned connectors, the bonding portion may be configured to provide enhanced pull strength between the connector and the fiber optic cable.

In some embodiments of any of the aforementioned connectors, the bonding portion may comprise a thermoplastic elastomer material.

In some embodiments of any of the aforementioned connectors, the bonding portion may comprise a methacrylate-based epoxy.

According to various aspect of the disclosure, a fiber optic connector may include a body portion having a first end portion structurally configured to connect a fiber optic cable to an interface of a network component, a coupling portion at a second end portion of the body portion opposite to the first end portion, and a bonding portion disposed on at least a portion of the coupling portion. The coupling portion may include an exterior surface portion structurally configured to comprise an engagement portion and a receiving portion defined by the engagement portion, and at least a portion of the receiving portion may be structurally configured to receive the bonding portion. The bonding portion is structurally configured to retain a reinforcing portion of a fiber optic cable during field installation of the connector on the fiber optic cable with the connector so as to prevent movement of the reinforcing portion relative to the body portion.

In some embodiments of any of the aforementioned connectors, the coupling portion may include a first coupling portion at the second end portion of the body portion a second coupling portion extending from the first coupling portion in a direction toward the first end portion and having a larger outside diameter than the first coupling portion.

In some embodiments of any of the aforementioned connectors, the exterior surface portion of the first coupling portion may include a first engagement portion structurally configured to define a first portion of the receiving portion, the exterior surface portion of the second coupling portion may include a second engagement portion structurally configured to define a second portion of the receiving portion, and at least one of the first engagement portion and the second engagement portion may be structurally configured to couple with a cap portion during field installation of the connector on the fiber optic cable.

In some embodiments of any of the aforementioned connectors, the bonding portion may be configured to prevent twisting, tearing, and/or slipping of the reinforcing portion relative to the body portion when coupling the engagement portion with a cap portion during the field installation of the connector on the fiber optic cable.

In some embodiments of any of the aforementioned connectors, the bonding portion may be configured to prevent twisting, tearing, and/or slipping of the reinforcing portion relative to the body portion.

In some embodiments of any of the aforementioned connectors, the bonding portion may be configured to provide enhanced pull strength between the connector and the fiber optic cable.

In some embodiments of any of the aforementioned connectors, the bonding portion may comprise a thermoplastic elastomer material.

In some embodiments of any of the aforementioned connectors, the bonding portion may comprise a methacrylate-based epoxy.

### BRIEF DESCRIPTION OF THE DRAWINGS

Further advantages and features of the present disclosure will become apparent from the following description and the accompanying drawings, to which reference is made.

FIG. 1 is a line representation of portions of a cable environment in which assorted embodiments can be practiced.

FIG. 2 is a line representation of portions of an example cable that can be employed in the environment of FIG. 1 in various embodiments.

FIG. 3 is a perspective view of portions of an example cable configured in accordance with various embodiments of the present disclosure.

FIG. 4 is a perspective view of portions of an example connector that may be utilized in the cable of FIG. 2 in some embodiments of the present disclosure.

FIG. 5 is a line representation of portions of an example connector configured and operated in accordance with various embodiments.

FIG. 6 is a perspective view line representation of portions of an example cable arranged in accordance with various embodiments of the present disclosure.

### DETAILED DESCRIPTION

Assorted embodiments are generally directed to a cable termination structurally configured to physically retain a reinforcing portion of a cable to allow efficient and accurate installation, and use, of the connector as part of a distributed network. With enhanced physical retention of a reinforcing portion of a cable, a connector may provide greater strength and operational resilience to the application of external force than a connector that more loosely retains a reinforcing portion of a cable.

Reference will now be made in detail to presently preferred embodiments and methods of the present disclosure, which constitute the best modes of practicing the present disclosure presently known to the inventors. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

As cabling, particularly fiber optic cables, becomes more prolific in signal transmission, the consistency and reliability of cable termination is emphasized. The termination, connection, or coupling of cables can result in inconsistencies that jeopardize the speed and accuracy of signal transmission. Hence, assorted embodiments are directed to improve the speed and consistency of field terminated fiber optic cables with connectors that employ a friction feature.

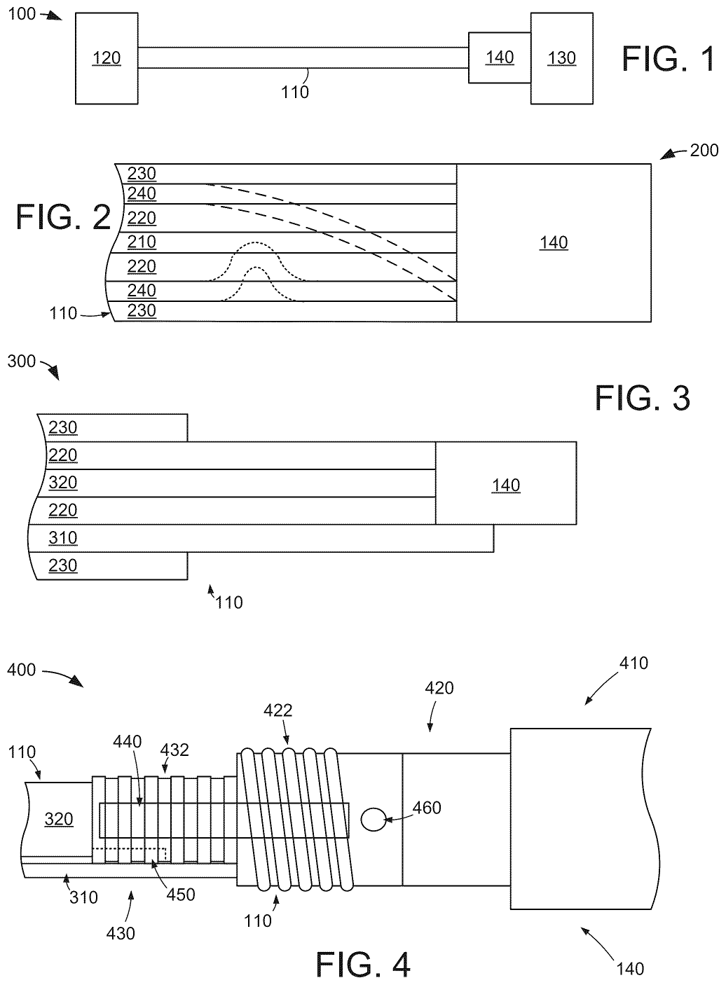

In FIG. 1, a line representation of an example cable environment 100 is generally shown. The environment 100 can have any number of cables 110 extending from a source 120 to a terminal 130. In some embodiments, a cable 110 is configured with a connector 140 that allows the cable 110 to connect and operate with the terminal component 130, such as an interface, device, or switch. It is noted that the cable 110 can be arranged with a diverse variety of different connectors 140 that provide different connection capabilities physically and/or operationally.

Portions of an example cable 110 are generally represented in the cable assembly 200 of FIG. 2. The cross-sectional line representation of the cable 110 in FIG. 2 conveys how a signal pathway 210 can be positioned within an insulator 220 and protective jacket 230. While a cable 110 can include any number of layers, such as shields and conductive foils, the cable 110 can remain susceptible to physical movement and forces beyond relatively tight ranges. For instance, a cable 110 employing a fiber optic signal pathway 210 can experience degraded performance and signal transmission reliability.

To increase the mechanical tolerances of a cable 110, one or more reinforcing materials 240 can be incorporated into portions of the cable 110. That is, fabrics, such as Kevlar or Mylar, can be employed as reinforcing material 240 along some, or all, of a cable's length to increase the tolerances of the cable 110 to withstand mechanical forces, such as bending, tension, and compression forces, without degraded signal transmission operation. Other embodiments of a cable reinforcing material 240 utilize solid, or hollow, filaments that continuously extend to strengthen the mechanical tolerances of the cable 110 without adding significant weight to the cable 110.

The use of one or more reinforcing materials 240 can increase the reliability of cable 110 installations, particularly cables with fiber optic signal pathways 210. However, the incorporation of a connector 140 into the cable 110 can present challenges that extend installation time and threaten the integrity of the cable 110. As a non-limiting example, attaching a connector 140 to the cable 110 can result in inadvertent twisting, kinking, and/or bundling of the reinforcing material 240, as shown by segmented lines, that focuses mechanical stress instead of distributing and diminishing such stress. Thus, the reinforcing materials 240 of a cable, if installed incorrectly, can reduce reliability and signal transmission performance due to increased susceptibility to mechanical stress.

FIG. 3 illustrates portions of an example cable assembly 300 that employs a reinforcing portion 310 in accordance with various embodiments. For example, the reinforcing portion may comprise a reinforcing material or fabric such as Kevlar, Mylar, or the like. As shown, stripping away the outer protective jacket 230 of the cable assembly 300 reveals the reinforcing portion 310 as well as a signal transmission portion 320, which may contain at least the signal pathway 210, such as one or more fiber optic cores, and an insulator 220 wrapped in an outer jacket 230, as generally displayed in FIG. 2. It is noted that the signal transmission portion 320 can be independently articulable relative to the reinforcing portion 310. Such loose cable construction with respect to the reinforcing portion 310 can allow for optimized reduction of mechanical stresses on the signal transmission portion 320 when the cable is fully assembled.

However, the independent movement of the reinforcing portion 310 relative to the signal transmission portion 320 can pose difficulties when terminating the cable assembly 300 with a connector 140. For instance, attachment of the connector 140 to a reinforced cable can involve stripping the outer jacket 230 of the cable prior to inserting and securing the signal transmission portion 320 of the cable into the connector 140 to prompt the manual securing of the reinforcing portion 310 to the connector 140, which is wrought with difficulties and risk as the reinforcing portion 310 is prone to movement relative to the secure signal transmission portion 320. That is, to properly attach the connector 140, an installer is forced to somehow retain the position and integrity of the reinforcing portion 310 while the connector 140 is fully secured to the cable in a manner that is conducive to peak signal transmission performance and mechanical reliability.

It is contemplated that the reinforcing material 310 may be attached to the connector 140 in a variety of different positions, such as to one lateral side, as shown in FIG. 3, or within a bore, or aperture, of the connector 140 along with the signal transmission portion. Likewise, the outer jacket 230 of the cable 110 may be removed from contact with the connector 140, as shown in FIG. 3, or integrated into the connector 140 in a manner similar, or dissimilar, to the reinforcing material 310. The ability to selectively position the outer jacket 230 and reinforcing material 310 in a variety of different locations on the connector 140 may provide customizable attachment options, but does not provide an efficient and reliable manner of securing either to the connector 140 during installation. For instance, applying an adhesive to retain the reinforcing material 310 requires physical retention over time and the use of a mechanical component to retain the reinforcing material 310 requires consistent application of force to maintain the proper characteristics of the reinforcing material 310 so that it adds integrity to the cable assembly 300.

These field termination issues with cables employing a reinforcing material 310 are addressed by various embodiments of the present disclosure. By incorporating a bonding portion in a cable connector 140 that is occupied with one or more bonding agents, the reinforcing material 310 may be retained more easily and reliably during, and after, connector 140 installation in the field. That is, the pre-application of a substance that physically retains the reinforcing material 310 without external, manual application of force to hold the reinforcing material 310 allows installation of the connector 140 onto the cable 110 to be efficient and reliable to produce a cable assembly 300 with heightened resilience to physical deformation thanks to the reinforcing material 310 integrated properly into the connector 140.

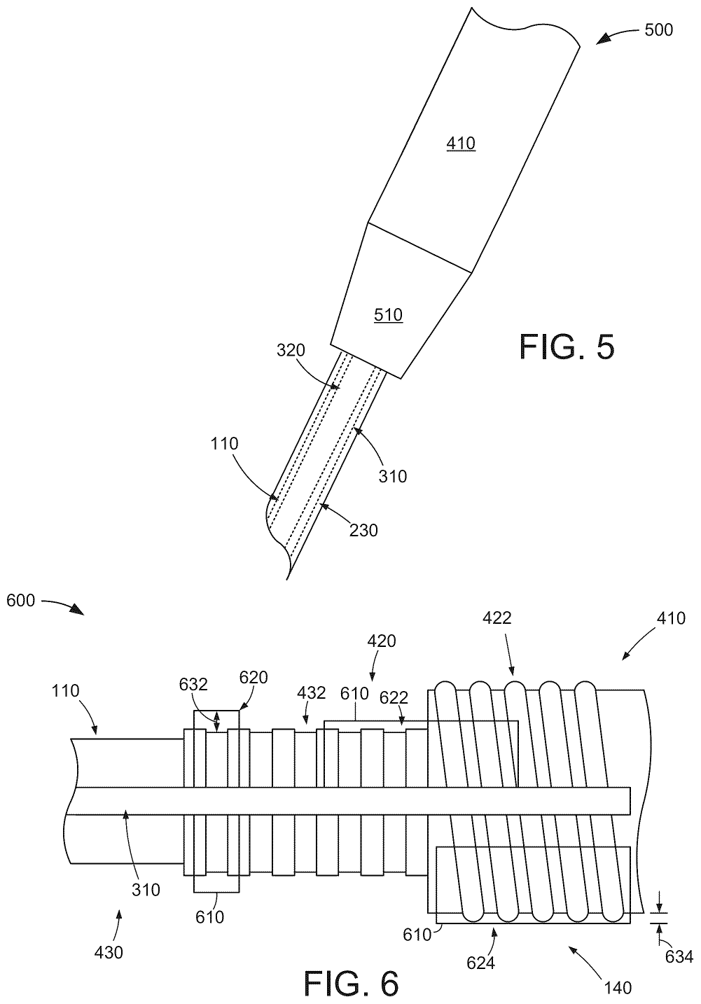

FIG. 4 illustrates portions of an example cable connector 400 that can be employed in the cable assemblies 200/300 of FIGS. 2 and 3 in accordance with various embodiments. The cable connector 400 has a body portion 410, a first coupling portion 420, and a second coupling portion 430 that collectively operate with a cap, as shown in FIG. 5, to physically secure the connector 400 to the cable 110 while utilizing the mechanical strengthening aspects of the reinforcing portion 310. The first and second coupling portions may collectively form a cap coupling portion. It is noted that the first coupling portion 420 can include an of engagement portion 422 that allows the body portion 410 to be secured to a cap, such as threads, keyed grooves, clamps, crimps, or selectable fasteners. Meanwhile, the second coupling portion 430 may have a different diameter and different grooves 432 than the first coupling portion 420 to promote secure attachment of the cap 510 and reinforcing portion 310 to form a unitary connector body portion 410.

Although not required or limiting, the cable connector 400 includes a bonding portion 440 that coats a selected amount of the first coupling portion 420 to promote stationary retention of a reinforcing material, such as reinforcing portion 310, while a cap 510 rotates to engage the engagement portion 422 of the first coupling portion 420. Some embodiments of the body portion 410 structurally configure the second coupling portion 430 to concurrently engage the cap 510 while securing the reinforcing material in place. It is contemplated that the material of the bonding portion 440 continuously, or discontinuously, extends to surround at least a portion of a periphery, or circumference, of the connector 400 and at least partially, or completely, fills a receiving portion between the engagement portion 422 of the first coupling portion 420 and/or a receiving portion between an engagement portion 432 of the second coupling portion 430. The material of the bonding portion 440 can reduce the risk of the reinforcing portion moving during installation of a cable 110 to the body portion 410 by increasing adhesion between the reinforcing portion and the underlying portion of the cable connector 400.

While not required, the second coupling portion 430 of the cable connector 400 can have a reduced diameter and longer longitudinal length, relative to the first coupling portion 420, to physically engage and secure the signal transmission portion 210 of a cable, such as a fiber optic core, fiber within an insulator, or fiber with a shield and insulator. The engagement portion 432 of the second coupling portion 430 may may including, for example, any number, size, and type of surface grooves to promote retention of the connector cap 510. As an example, the second coupling portion 430 may have ring protrusions that are separated to define annular grooves, which contrast the continuous and angular recesses that define the engagement portion 422 of the first coupling portion 420.

In some embodiments, aspects of the body portion 410 may be structurally configured with physical features that complement the bonding material to retain the reinforcing material in place during, and after, installation with the connector body portion 410 and cap portion 510. For instance, regions of the first coupling portion 420 and/or the second coupling portion 430 may be textured, notched, or otherwise shaped to physically contact the reinforcement material to promote stationary retention at least during installation of the cap portion 510. More specifically in a non-limiting embodiment, a notch 450 may continuously extend into the body portion 410, as shown by segmented lines in FIG. 4, that is occupied by the reinforcing material with, or without, the notch 450 being partially, or completely, filled with bonding material. Other non-limiting embodiments may provide a protrusion 460, such as a tab, post, or cantilevered structure, that contacts the reinforcing material, with or without the presence of bonding material on the protrusion 460.

The line representation of an example cable assembly 500 illustrated in FIG. 5 conveys how a connector cap 510 can engage and cover the second coupling portion 430 and/or the first coupling portion 420 of a connector 140. The cap portion 510 provides mechanical and environmental protection to the connector 140 as well as portions of the terminated end of the cable 110. That is, the cap 510 secures the reinforcing portion 310 of the cable 110 between at least the second coupling portion 430 and the first coupling portion 420 of the connector body 410 while extending to contact and cover the outer jacket portion 230 of the cable 110, as shown by segmented lines of the aspects of the cable hidden underneath the outer jacket 230.

The construction, size, and attachment mechanism of the cap portion 510 is not limited to a particular configuration. Yet, some embodiments arrange the cap 510 as a single piece of material that screws onto the first coupling portion 420 of the connector body 410 to cover the second coupling portion 430 and provide rigid structural support for at least the signal transmission aspects of the cable 110. The connector cap 510, in other embodiments, can include a combination of rigid and flexible aspects that allow movement of the cable 110 without placing undue mechanical stress on the junction of the cable 110 and connector body portion 410.

FIG. 6 illustrates a line representation of aspects of a cable assembly 600 structurally configured to provide secure retention of a reinforcing portion 310 during, and after, installation of a cable 110 into a connector body portion 410. The side view of the body portion 410 of the cable assembly 600 conveys how the bonding material 610 may be positioned in various selected regions 620 with one or more predetermined thicknesses 630, as defined by a radial distance from the surface of the body portion 410.

Some embodiments arrange a bonding portion 620 with multiple different materials, or sub-regions, that optimize cable assembly time and accuracy. For instance, a bonding portion 620 can provide a first thickness 632 of bonding material 610, such as a methacrylate-based epoxy, around over half of the external surface area of the second coupling portion 430 and a different, second thickness 634 of bonding material 610 around over half of the external surface area of the first coupling portion 420. The material 610 applied to the bonding portion 620 may be a resin with a base solvent of Methyl Ethyl Ketone that forms a thermoplastic elastomer bonding agent with an indefinite shelf life.

In practice, portions of a thermoplastic elastomer bonding material 610 can be brushed, sprayed, or otherwise applied to one or more selected regions 620 of the cable connector 600 that will provide increased reinforcing material 310 retention until a cap portion 510 secures and covers the first coupling portion 420. It is contemplated that the bonding material 610 is cured at an elevated temperature for a predetermined time before the cable connector 600 is utilized in the field to connect to a cable 110.

A cable connector 600, in accordance with various embodiments, can employ separate bonding portions 622/624 that act collectively to promote reinforcing material retention during and after assembly of a field terminated cable. The combination of thread undulations in the first coupling portion 420 along with intermittent volumes of bonding material 610 in selected bonding portions 622/624 may provide optimal engagement and/or retention of the reinforcing material 610 of a cable 110 that a single bonding portion 620 may not. For instance, bonding portions 622/624 may be isolated to, but separated on, the first coupling portion 420 or the second coupling portion 430 of the body portion 410, which may provide ample reinforcing material 310 retention with reduced torque needed to remove the connector cap 510 after initial installation. As a result, the speed and/or accuracy of cable connector 600 alteration and reassembly may be improved compared to body portions 410 simply employing physical topography to engage the reinforcing material 310.

Also, with respect to the various embodiments of the present disclosure, the components of the cable 110 can be constructed of various materials which have some degree of elasticity or flexibility. The elasticity enables the cable 110 to flex or bend in accordance with broadband communications standards, installation methods or installation equipment. Also, the radial thicknesses of the cable 110, the signal pathway conductor 210, insulator 220, reinforcing material 240, any shielding layers, and the outer jacket 230 can vary based upon parameters corresponding to broadband communication standards or installation equipment.

This disclosure covers the mechanism of installation of a field terminated fiber optic connector with reinforced jacketed cable of any diameter using a bonding agent with an indefinite shelf life as a coating on a fiber optic connector body to prevent the slipping, twisting, and tearing of the strength member (e.g., Kevlar) during the assembly of the field terminated connector.

In one example, a resin with a base solvent of Methyl Ethyl Ketone was used as the thermoplastic elastomer bonding agent with indefinite shelf life as a coating on the rear body. A small amount of this thermoplastic elastomer was brushed onto the rear body of the fiber optic connector. In this example, thermoplastic elastomer covered 30-50% of the threaded area. This product can be applied to the rear body during production and can already be on the connector body when it is packaged and manufactured. Once the thermoplastic elastomer is cured, it takes on the form of a thick resilient resin that clings to the rear body.

It should be appreciated that the connector described herein and the method application of having a bonding agent such as a thermoplastic elastomer resin of Methyl Ethyl Ketone as a coating prevents the twisting, tearing, and slipping of the strength member (Kevlar) of a reinforced jacketed fiber optic cable during the field installation of a field terminated fiber optic connector. The connector and method also allow for better mechanical performance in Proof test as per GR-326 standard and in TIA-568. The use of the elastomer resin allows for greater pull strength between the connector and the cable.

This disclosed connector and method improve the installation yield for field terminated fiber optic connectors with reinforced jacketed cable of any diameter by preventing the twisting of Kevlar around the fiber optic cable during installation of the connector. The disclosed connector and method improve the mechanical performance for the field terminated fiber optic connectors with reinforced jacketed cable of any diameter by preventing the premature slipping and tearing of Kevlar when the connector is under mechanical stresses. This disclosed connector and method improve the efficiency of the Kevlar when the connector is under mechanical load by preventing any twisting between the Kevlar and the 900 um buffered fiber during installation, such that the Kevlar is able to optimally perform in its role as a strength member without prematurely transferring the load to the 900 um buffered fiber optic cable.

Additional advantages of this connector and method are less reliance of installer experience when they are installing this type of connector. This new installation method for field terminated connectors leads to a higher installation yield with less experienced installers while using less components in the connector design and less steps in the installation instructions for the connector.

Additional embodiments include any one of the embodiments described above, where one or more of its components, functionalities or structures is interchanged with, replaced by or augmented by one or more of the components, functionalities or structures of a different embodiment described above.

It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A fiber optic connector configured to prevent movement of a reinforcing portion of a fiber optic cable during field termination of the fiber optic cable, comprising:
a body portion having a first end portion structurally configured to connect a fiber optic cable to an interface of a network component;
a first coupling portion at a second end portion of the body portion opposite to the first end portion;
a second coupling portion continuously extending from the first coupling portion in a direction toward the first end portion and having a larger outside diameter than the first coupling portion;
a bonding portion disposed on at least a portion of the first coupling portion and at least a portion of the second coupling portion;
wherein the first coupling portion includes an exterior surface portion structurally configured to comprise a first engagement portion and a first receiving portion defined by the first engagement portion;
wherein the second coupling portion includes an exterior surface portion structurally configured to comprise a second engagement portion and a second receiving portion defined by the second engagement portion;
wherein at least a portion of the first receiving portion and at least a portion of the second receiving portion are structurally configured to receive the bonding portion;
wherein the first engagement portion and the second engagement portion are structurally configured to couple with a cap portion; and
wherein the bonding portion is structurally configured to retain a reinforcing portion of a fiber optic cable during field installation of the connector on the fiber optic cable with the connector so as to prevent movement of the reinforcing portion relative to the body portion.

2. The fiber optic connector of claim 1, wherein the bonding portion is configured to prevent twisting, tearing, and/or slipping of the reinforcing portion relative to the body portion.

3. The fiber optic connector of claim 1, wherein the bonding portion is configured to prevent twisting, tearing, and/or slipping of the reinforcing portion relative to the body portion when coupling the first engagement portion and the second engagement portion with a cap portion during field installation of the connector on the fiber optic cable.

4. The fiber optic connector of claim 1, wherein the bonding portion is configured to provide enhanced pull strength between the connector and the fiber optic cable.

5. The fiber optic connector of claim 1, wherein the bonding portion comprises a thermoplastic elastomer material.

6. The fiber optic connector of claim 1, wherein the bonding portion comprises a methacrylate-based epoxy.

7. A fiber optic connector configured to prevent movement of a reinforcing portion of a fiber optic cable during field termination of the fiber optic cable, comprising:
a body portion having a first end portion structurally configured to connect a fiber optic cable to an interface of a network component;
a first coupling portion at a second end portion of the body portion opposite to the first end portion;
a second coupling portion extending from the first coupling portion in a direction toward the first end portion and having a larger outside diameter than the first coupling portion;
a bonding portion disposed on at least a portion of at least one of the first coupling portion and the second coupling portion;
wherein the first coupling portion includes an exterior surface portion comprising a first receiving portion;
wherein the second coupling portion includes an exterior surface portion comprising a second receiving portion;
wherein at least a portion of at least one of the first receiving portion and the second receiving portion is structurally configured to receive the bonding portion; and
wherein the bonding portion is structurally configured to retain a reinforcing portion of a fiber optic cable during field installation of the connector on the fiber optic cable with the connector so as to prevent movement of the reinforcing portion relative to the body portion.

8. The fiber optic connector of claim 7, wherein the exterior surface portion of the first coupling portion comprises a first engagement portion structurally configured to define the first receiving portion;
wherein the exterior surface portion of the second coupling portion comprises a second engagement portion structurally configured to define the second receiving portion; and
wherein at least one of the first engagement portion and the second engagement portion is structurally configured to couple with a cap portion during field installation of the connector on the fiber optic cable.

9. The fiber optic connector of claim 7, wherein the bonding portion is configured to prevent twisting, tearing, and/or slipping of the reinforcing portion relative to the body portion when coupling at least one of the first engagement portion and the second engagement portion with a cap portion during the field installation of the connector on the fiber optic cable.

10. The fiber optic connector of claim 7, wherein the bonding portion is configured to prevent twisting, tearing, and/or slipping of the reinforcing portion relative to the body portion.

11. The fiber optic connector of claim 7, wherein the bonding portion is configured to provide enhanced pull strength between the connector and the fiber optic cable.

12. The fiber optic connector of claim 7, wherein the bonding portion comprises a thermoplastic elastomer material.

13. The fiber optic connector of claim 7, wherein the bonding portion comprises a methacrylate-based epoxy.

14. A fiber optic connector configured to prevent movement of a reinforcing portion of a fiber optic cable during field termination of the fiber optic cable, comprising:
a body portion having a first end portion structurally configured to connect a fiber optic cable to an interface of a network component;
a coupling portion at a second end portion of the body portion opposite to the first end portion;
a bonding portion disposed on at least a portion of the coupling portion;
wherein the coupling portion includes an exterior surface portion structurally configured to comprise an engagement portion and a receiving portion defined by the engagement portion;
wherein at least a portion of the receiving portion is structurally configured to receive the bonding portion; and
wherein the bonding portion is structurally configured to retain a reinforcing portion of a fiber optic cable during field installation of the connector on the fiber optic cable with the connector so as to prevent movement of the reinforcing portion relative to the body portion.

15. The fiber optic connector of claim 14, wherein the coupling portion comprises:
a first coupling portion at the second end portion of the body portion; and
a second coupling portion extending from the first coupling portion in a direction toward the first end portion and having a larger outside diameter than the first coupling portion.

16. The fiber optic connector of claim 15, wherein the exterior surface portion of the first coupling portion comprises a first engagement portion structurally configured to define a first portion of the receiving portion;
wherein the exterior surface portion of the second coupling portion comprises a second engagement portion structurally configured to define a second portion of the receiving portion; and
wherein at least one of the first engagement portion and the second engagement portion is structurally configured to couple with a cap portion during field installation of the connector on the fiber optic cable.

17. The fiber optic connector of claim 14, wherein the bonding portion is configured to prevent twisting, tearing, and/or slipping of the reinforcing portion relative to the body portion when coupling the engagement portion with a cap portion during the field installation of the connector on the fiber optic cable.

18. The fiber optic connector of claim 14, wherein the bonding portion is configured to prevent twisting, tearing, and/or slipping of the reinforcing portion relative to the body portion.

19. The fiber optic connector of claim 14, wherein the bonding portion is configured to provide enhanced pull strength between the connector and the fiber optic cable.

20. The fiber optic connector of claim 14, wherein the bonding portion comprises a thermoplastic elastomer material.

21. The fiber optic connector of claim 14, wherein the bonding portion comprises a methacrylate-based epoxy.
